(19) United States
(12) Patent Application Publication
(10) Pub. No.: US 2015/0106832 A1
(43) Pub. Date: Apr. 16, 2015

(54) CONTENT PLAYBACK DEVICE AND MOBILE TERMINAL

(71) Applicants: Hiroyuki Yokota, Kobe-shi (JP); Yoshihiro Nakai, Kobe-shi (JP)

(72) Inventors: Hiroyuki Yokota, Kobe-shi (JP); Yoshihiro Nakai, Kobe-shi (JP)

(73) Assignee: Mitsubishi Electric Corporation, Tokyo (JP)

(21) Appl. No.: 14/397,637

(22) PCT Filed: Jul. 2, 2012
(86) PCT No.: PCT/JP2012/066861

§ 371 Date: Oct. 28, 2014

(51) Int. Cl. H04N 21/258; H04N 21/6334; H04N 21/436; H04N 21/414

(52) U.S. Cl. CPC H04N 21/25816; H04N 21/41407; H04N 21/41422; H04N 21/6334; H04N 21/436
USPC 725/25

(57) ABSTRACT

An authenticated mobile terminal 3a holds device information showing a mobile terminal 3b which is permitted to play back a content, and, when the mobile terminal 3b makes a request for playback of a content on the basis of restricted authentication information for permitting a playback of the content on a predetermined condition, the restricted authentication information being provided from the mobile terminal 3a to the permitted mobile terminal 3b, and the mobile terminal 3b is determined by using the device information held, the content provided by a media server 2 is played back on the predetermined condition in response to the request from the mobile terminal 3b.

### FIELD OF THE INVENTION

The present invention relates to a content playback device and a mobile terminal.

### BACKGROUND OF THE INVENTION

For example, patent reference 1 discloses a content playback system which when having been playing back a content which is managed by a content server, such as a Web page or a moving image, by using a content playback device, can interrupt the playback and continue playing back the content by using another content playback device. This system transmits playback interruption information showing the content whose playback has been interrupted from the content playback device to a mobile terminal by using a short distance radio or the like to provide the playback interruption information from this mobile terminal to the other content playback device, thereby continuing playing back the content.

### RELATED ART DOCUMENT

### Patent Reference

Patent reference 1: Japanese Unexamined Patent Application Publication No. 2006-30177

### SUMMARY OF THE INVENTION

### Problems to be Solved by the Invention

A problem with the conventional technology represented by patent reference 1 is that an authenticated user cannot permit any other user watching, and therefore no other users can continue watching.

For example, when a plurality of passengers in a vehicle have been watching a content which has been being played back on the basis of the authentication using a mobile terminal and one of the passengers owning the authenticated mobile terminal gets off the vehicle, the other passengers not having the mobile terminal cannot play back the content, and therefore become unable to continue watching.

The present invention is made in order to solve the above-mentioned problem, and it is therefore an object of the present invention to provide a content playback device and a mobile terminal that can continue playing back a content by using another mobile terminal permitted by an authenticated mobile terminal.

### Means for Solving the Problem

In accordance with the present invention, there is provided a content playback device that, in response to a request from an authenticated mobile terminal which a server that manages contents has authenticated, plays back a content provided by the above-mentioned server, the content playback device including: an authentication information manager that holds device information showing a permitted mobile terminal which is permitted to play back the content by the authenticated mobile terminal; a controller that, when the permitted mobile terminal makes a request for playback of the content on the basis of restricted authentication information for permitting a playback of the content on a predetermined condition, the restricted authentication information being provided from the authenticated mobile terminal to the above-mentioned permitted mobile terminal, determines this mobile terminal by using the device information held by the authentication information manager; and a playback processor that, when the controller determines the permitted mobile terminal, plays back the content provided from the server on the predetermined condition in response to the request from the above-mentioned mobile terminal.

### Advantages of the Invention

In accordance with the present invention, there is provided an advantage of being able to continue playing back a content by using another mobile terminal which is permitted by the authenticated mobile terminal.

### BRIEF DESCRIPTION OF THE FIGURES

FIG. 1 is a view showing an outline of a content playback system in accordance with the present invention;

FIG. 2 is a block diagram showing the structure of a content playback device in accordance with Embodiment 1 of the present invention;

FIG. 3 is a block diagram showing the structure of a media server;

FIG. 4 is a block diagram showing the structure of a mobile terminal;

FIG. 5 is a view showing an outline of a content playback in accordance with Embodiment 1;

FIG. 6 is a timing chart of a content continuous playback in a content playback system in accordance with Embodiment 1;

FIG. 7 is a flow chart showing the operation of the mobile terminal when making a request for authentication information;

FIG. 8 is a flow chart showing the operation of the content playback device when permitting watching;

FIG. 9 is a flow chart showing the operation of the mobile terminal when permitting watching;

FIG. 10 is a view showing an outline of a content playback in accordance with Embodiment 2; and

FIG. 11 is a timing chart of a content continuous playback in a content playback system in accordance with Embodiment 2.

### EMBODIMENTS OF THE INVENTION

Hereafter, in order to explain this invention in greater detail, the preferred embodiments of the present invention will be described with reference to the accompanying drawings.

### Embodiment 1

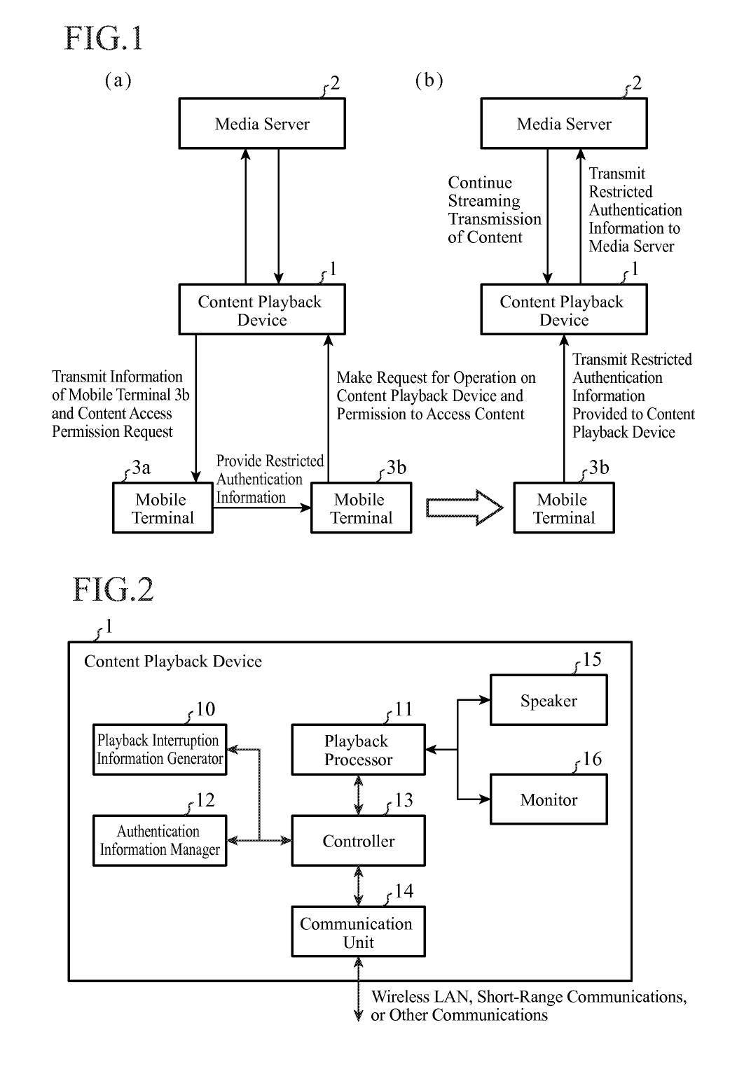

FIG. 1 is a view showing an outline of a content playback system in accordance with the present invention. The content playback system shown in FIG. 1 is provided with a content playback device 1, a media server 2, and mobile terminals 3a and 3b. The content playback device 1 plays back a content transmitted thereto from the media server 2. The media server 2 manages contents and transmits a content to the content playback device 1. In principle, in the content playback system in accordance with the present invention, the content playback device 1 plays back a content transmitted thereto from the media server 2 in response to a request from the authenticated mobile terminal 3a which has been authenticated by the media server 2.

However, when the owner of the mobile terminal 3b which has not been authenticated by the media server 2 is also watching a content, which is being played back by using the mobile terminal 3a, together with the owner of the mobile terminal 3a, if the owner of the mobile terminal 3a stops watching and moves, conventionally, the owner of the mobile terminal 3b is not enabled to continue watching the content.

More specifically, because the content playback device 1 plays back a content by using authentication information which the mobile terminal 3a manages after the mobile terminal 3a has been authenticated by the media server 2, the mobile terminal 3b which does not have this authentication information cannot continue the playback of the content.

To solve this problem, in accordance with the present invention, as shown in FIG. 1(a), when the owner of the authenticated mobile terminal 3a stops watching and moves, the content playback system provides restricted authentication information for the mobile terminal 3b by using the mobile terminal 3a. For example, the mobile terminal 3b makes a request of the content playback device 1 for an operation on the content playback device 1 and permission to access the content. In response to this request, the content playback device 1 transmits the above-mentioned request made by the mobile terminal 3b to the authenticated mobile terminal 3a.

The authenticated mobile terminal 3a provides the restricted authentication information for the mobile terminal 3b which is the source of the request.

When continuing the playback of the content by using the mobile terminal 3b, the mobile terminal 3b transmits a content access permission request to which the restricted authentication information is added to the content playback device 1, as shown in FIG. 1(b). The content playback device 1 transmits the restricted authentication information acquired from the content access permission request to the media server 2, and the media server 2 authenticates the mobile terminal 3b, so that the streaming transmission of the content is continued. As a result, the content playback device 1 can play back the content received from the media server 2, and the owner of the mobile terminal 3b can continue watching.

The restricted authentication information is authentication information for permitting a playback of the content on a predetermined condition. For example, a condition that permits a playback of the content only during a fixed time period is provided.

Further, the fixed time period can be a time period which elapses before the continuously watching of the remaining content is completed. A playbackable time period, such as two weeks, can be set up as the fixed time period.

In addition, the user who has provided the permission can be enabled to cancel the permission by invalidating the restricted authentication information stored in the content playback device 1 and provided for the mobile terminal 3b by using the mobile terminal 3a.

FIG. 2 is a block diagram showing the structure of the content playback device in accordance with Embodiment 1 of the present invention. The content playback device 1 in accordance with the present invention plays back a content to present this content to users. A vehicle-mounted information device having a content playback function, such as a navigation device or a display device used for rear seat entertainment, can be provided as the content playback device. As an alternative, the content playback device 1 can be a mobile terminal. For example, the content playback device can be an information device, such as a smart phone or a mobile information terminal, which also functions as a display device, or a PND (Portable Navigation Device).

As shown in FIG. 2, the content playback device 1 is constructed in such a way as to include a playback interruption information generator 10, a playback processor 11, an authentication information manager 12, a controller 13, a communication unit 14, a speaker 15, and a monitor 16.

When a playback of a content is interrupted, the playback interruption information generator 10 generates playback interruption information showing a position where the playback has been interrupted.

The playback processor 11 plays back a content provided therefor by the media server 2 in response to a request from a mobile terminal authenticated by the media server 2.

The authentication information manager 12 holds and manages authentication information which is used when the owner of each of the mobile terminals 3a and 3b watches a content.

The authentication information held by the authentication information manager 12 includes the restricted authentication information of the mobile terminal 3b in addition to the authentication information of the mobile terminal 3a.

The controller 13 controls each of the operations of the playback interruption information generator 10, the playback processor 11, the authentication information manager 12, and the communication unit 14. The communication unit 14 communicates with the media server 2 and the mobile terminals 3a and 3b, and uses a radio communication system, such as a wireless LAN (Local Area Network) or short-range radio communications like Bluetooth (registered trademark; this description will be omitted hereafter).

The speaker 15 is a sound output unit that outputs a sound of a content played back by the playback processor 11. Further, the monitor 16 is a video output unit that outputs a video of the content played back by the playback processor 11.

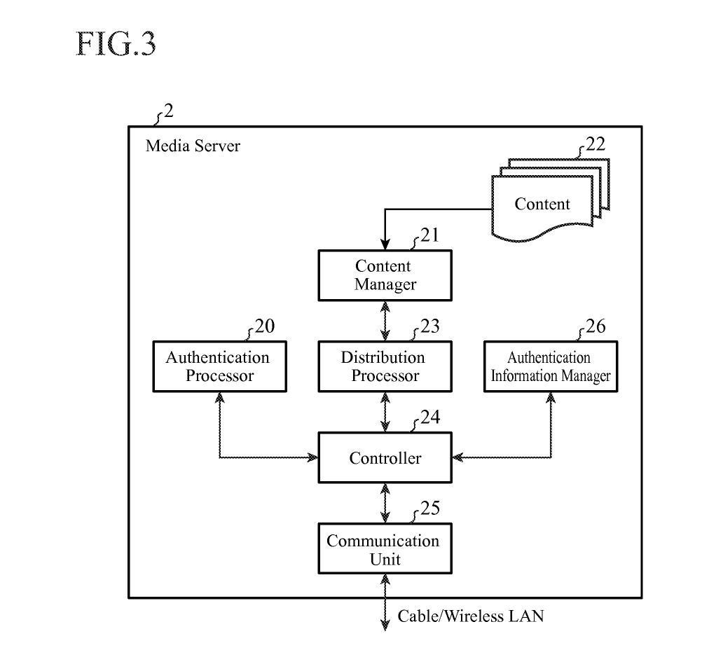

FIG. 3 is a block diagram showing the structure of the media server. As shown in FIG. 3, the media server 2 is constructed in such a way as to include an authentication processor 20, a content manager 21, contents 22, a distribution processor 23, a controller 24, a communication unit 25, and an authentication information manager 26.

The authentication processor 20 authenticates the mobile terminals 3a and 3b by using the authentication information acquired from the mobile terminals 3a and 3b via the content playback device 1. The content manager 21 manages the contents 22 provided by the media server 2. The distribution processor 23 distributes a content which is requested by the content playback device 1 or a mobile terminal. For example, the distribution processor distributes a content by using stream transmission.

The controller 24 controls each of the operations of the authentication processor 20, the content manager 21, each content 22, the distribution processor 23, the communication unit 25, and the authentication information manager 26. The communication unit 25 communicates with the content playback device 1 and the mobile terminals 3a and 3b, and uses a radio communication system, such as a wireless LAN or short-range radio communications like Bluetooth.

The authentication information manager 26 holds and manages authentication information which the media server 2 uses in order to authenticate a user. The authentication information includes device information specific to a mobile terminal which a user possesses (e.g., hardware identification information specific to the mobile terminal, and, when the mobile terminal has a phone function, a phone number, designation of the owner, etc.).

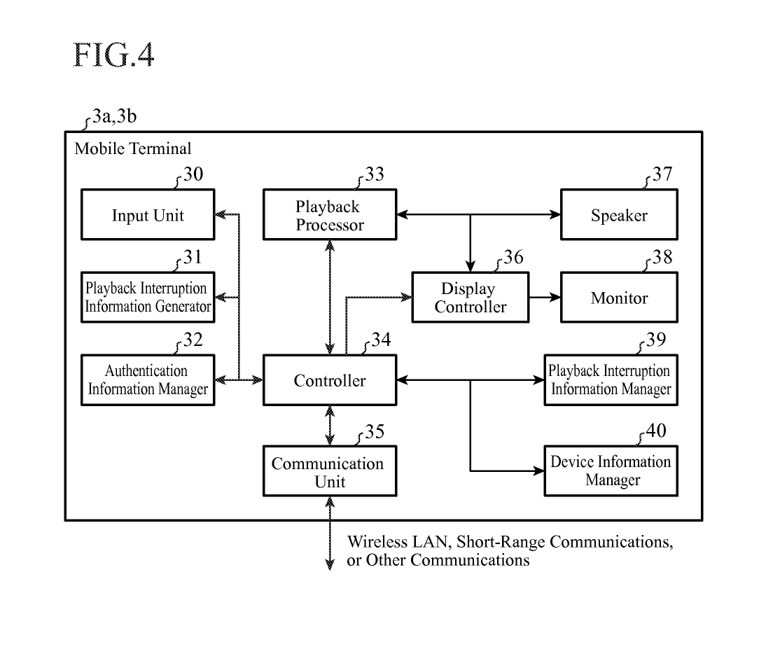

FIG. 4 is a block diagram showing the structure of each of the mobile terminals. As shown in FIG. 4, each of the mobile terminals 3a and 3b is constructed in such a way as to include an input unit 30, a playback interruption information generator 31, an authentication information manager 32, a playback processor 33, a controller 34, a communication unit 35, a display controller 36, a speaker 37, a monitor 38, a playback interruption information manager 39, and a device information manager 40. The input unit 30 accepts an operational input from a user. When a playback of a content is interrupted, the playback interruption information generator 31 generates playback interruption information showing a position where the playback has been interrupted.

The authentication information manager 32 holds and manages the authentication information which is provided for each of the mobile terminals 3a and 3b in order to watch a content which the media server 2 provides.

The authentication information manager 32 of the mobile terminal 3a holds the authentication information which is provided for the mobile terminal 3a in advance by the media server 2. Further, the authentication information manager 32 of the mobile terminal 3b holds the restricted authentication information which is provided by the authenticated mobile terminal 3a.

The playback processor 33 plays back a content provided therefor by the media server 2 in response to a request from each of the mobile terminals 3a and 3b authenticated by the media server 2.

The controller 34 controls each of the operations of the input unit 30, the playback interruption information generator 31, the authentication information manager 32, the playback processor 33, the communication unit 35, the playback interruption information manager 39, and the device information manager 40. The communication unit 35 communicates with the content playback device 1 and the media server 2, and uses a radio communication system, such as a wireless LAN or short-range radio communications like Bluetooth.

The display control unit 36 performs a control operation of displaying the content played back by the playback processor 33 on the monitor 38. The speaker 37 is a sound output unit that outputs a sound of the content played back by the playback processor 33. The monitor 38 is a video output unit that outputs a video of the content played back by the playback processor 33.

When a playback of a content which is requested by the local terminal is interrupted, the playback interruption information manager 39 manages the playback interruption information generated by the playback interruption information generator 31.

The device information manager 40 holds and manages device information specific to the local terminal. The device information includes the above-mentioned device information specific to the mobile terminal.

Next, the operation of the content playback system will be explained.

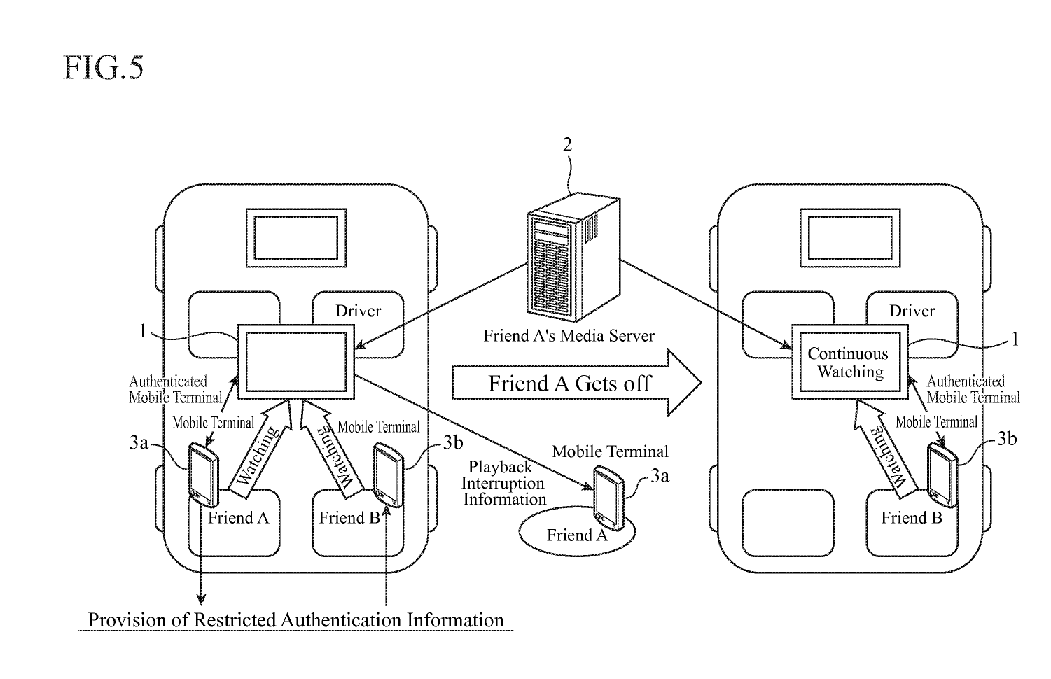

Hereafter, an explanation will be made by taking, as an example, a case in which when a friend A and a friend B are watching a content of the media server 2 owned by the friend A who possesses the mobile terminal 3a by using the content playback device 1 (display device) mounted in a vehicle, the friend A stops watching and then gets off the vehicle, and, even after that, the friend B continues watching the same content, as shown in FIG. 5.

In this case, conventionally, when the friend A stops watching and leaves the content playback device 1 while carrying the mobile terminal 3a, devices, in the vehicle, including the content playback device 1 lose a right to access the content which the media server 2 provides, and the other friend becomes unable to watch the content continuously.

In contrast with this, in accordance with the present invention, when the friend B who possesses the mobile terminal 3b would like to watch the content continuously even after the friend A gets off the vehicle, by using the mobile terminal 3a the system provides a right to access the content and the media server 2 for the mobile terminal 3b while imposing a restriction on the right, thereby solving the above-mentioned problem.

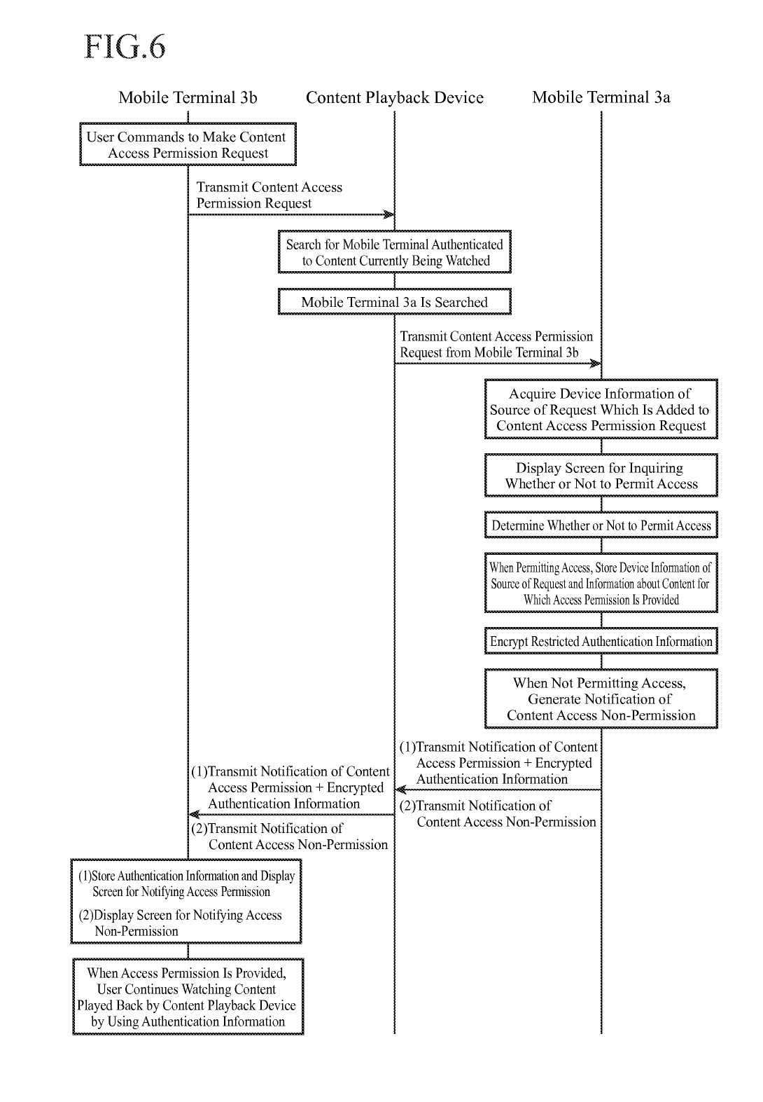

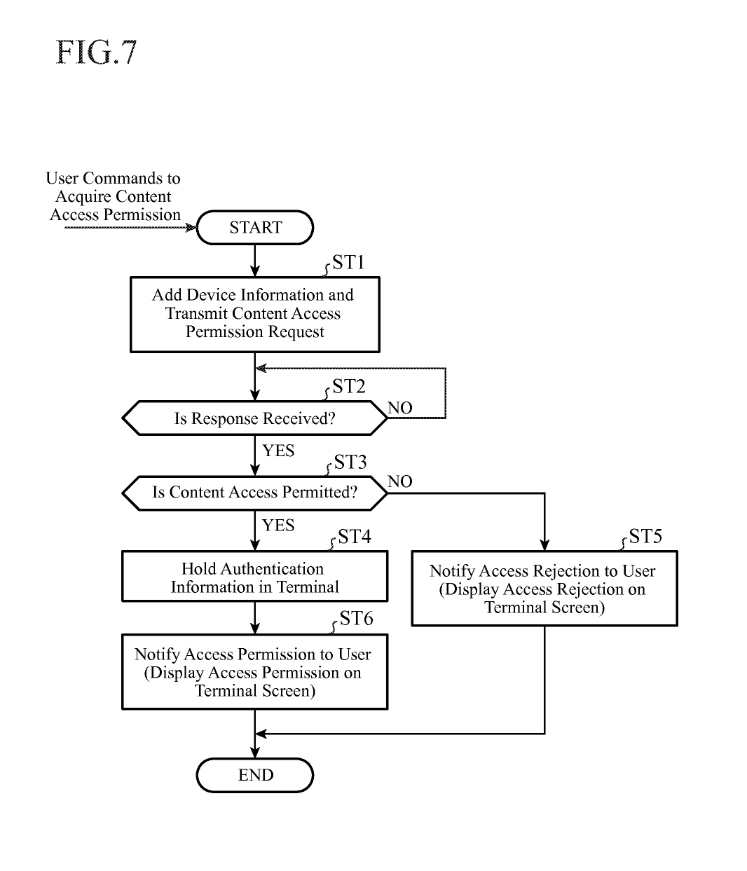

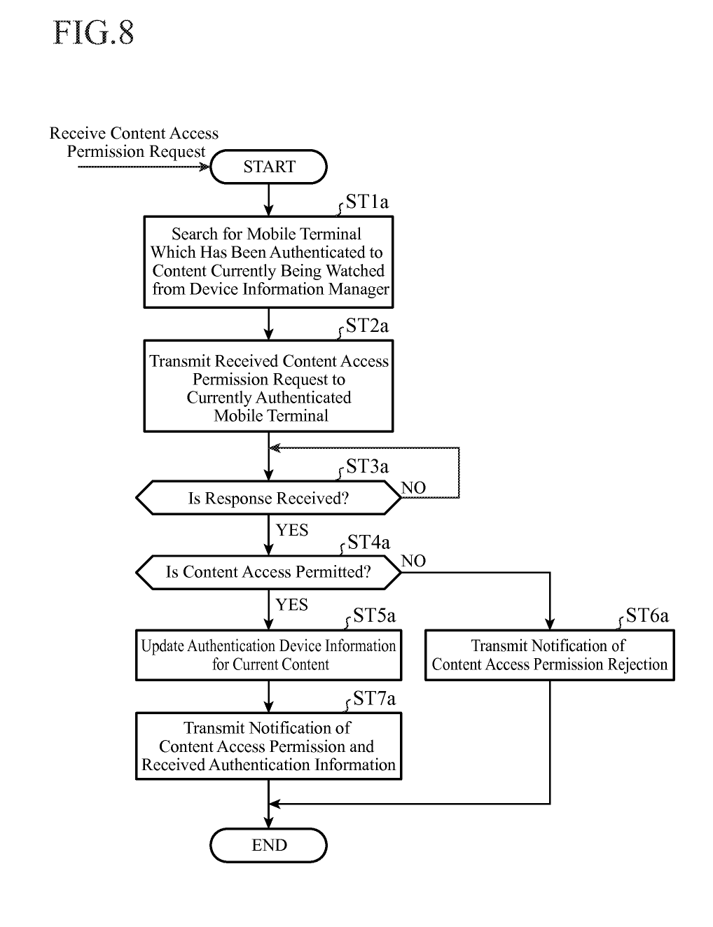

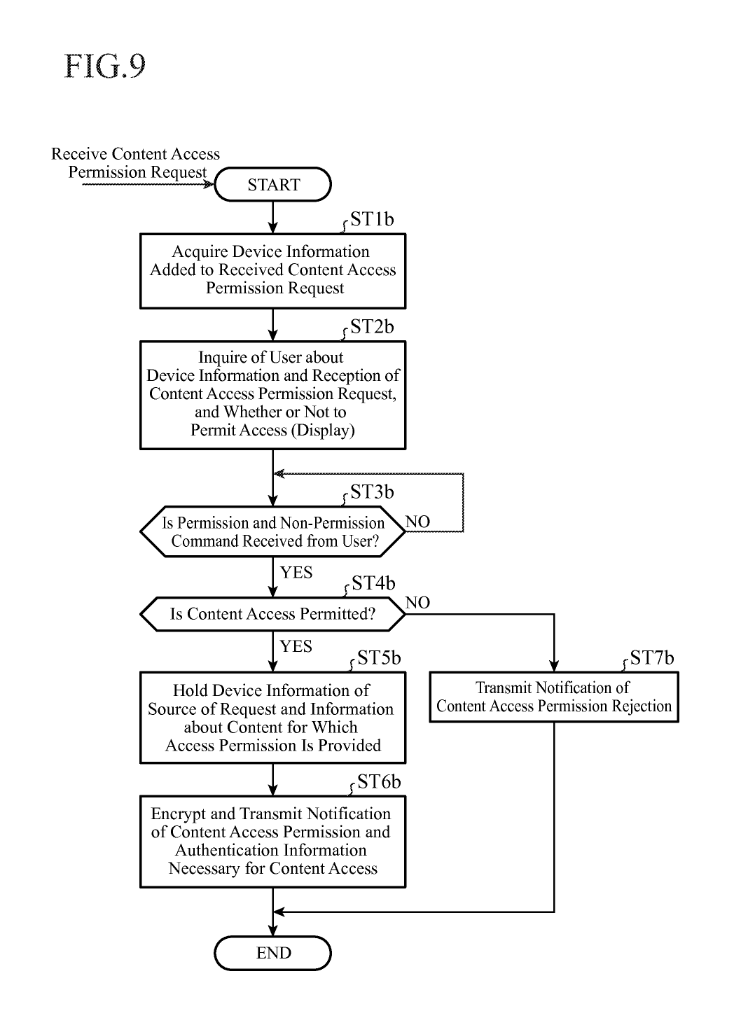

FIG. 6 is a timing chart of a content continuous playback in the content playback system in accordance with Embodiment 1. Further, FIG. 7 is a flow chart showing the operation of the mobile terminal 3b when making a request for authentication information. FIG. 8 is a flow chart showing the operation of the content playback device 1 when permitting watching. In addition, FIG. 9 is a flow chart showing the operation of the mobile terminal 3a when permitting watching. With reference to these figures, the details of processing of continuing watching a content by using the mobile terminal 3b will be explained.

As shown in FIG. 6, when the friend A is about to get off the vehicle, the friend B makes an operational input using the input unit 30 of the mobile terminal 3b to command the content playback device 1 to make a request for permission to access the content which the friends have been watching. The controller 34 of the mobile terminal 3b interprets the command inputted by the input unit 30, and when determining that the command is the above-mentioned request, acquires the device information specific to the local terminal (mobile terminal 3b) from the device information manager 40, and transmits a content access permission request including this information to the content playback device 1 by using the communication unit 35. The process including up to this process correspond to step ST1 of FIG. 7.

A communication system which the communication unit 35 uses can be a wireless LAN, short-range radio communications, such as Bluetooth, or communications which are performed via another network, such as a cable network.

When receiving a so-called content access permission request which is a request for permission to access and play back the content from the mobile terminal 3b, the controller of the content playback device 1 searches for the authenticated mobile terminal which is authenticated to the content currently being watched on the basis of the authentication information held by the authentication information manager 12, as shown in FIG. 6. In this case, because the friend A is authenticated by the media server 2, the mobile terminal 3a is searched as the authenticated mobile terminal authenticated by the media server 2 on the basis of the device information included in the authentication information.

Next, the controller 13 transmits the content access permission request to which the device information of the mobile terminal 3b is added to the authenticated mobile terminal 3a by using the communication unit 14. The processes including up to this process correspond to steps ST1a and ST2a of FIG. 8.

Also a communication system which the communication unit 14 uses can be a wireless LAN, short-range radio communications, such as Bluetooth, or communications which are performed via another network, such as a cable network.

The controller 34 of the mobile terminal 3a acquires the device information of the source of the request which is added to the content access permission request received by the communication unit 35, and determines the mobile terminal 3b and its owner (friend B) from this device information, as shown in FIG. 6.

Next, the controller 34 commands the display controller to display a screen showing that the content access permission request from the friend B (mobile terminal 3b) has been made and inquiring whether or not to honor this request on the monitor 38. The processes including up to this process correspond to processes of steps ST1b and ST2b of FIG. 9.

When the user (friend A) who refers to the above-mentioned screen displayed on the monitor 38 selects content access permission for the friend B by using the input unit 30, the controller 34 of the mobile terminal 3a stores the device information of the source of the request and information showing the content for which the access permission is provided in the authentication information manager 12. The processes including up to this process correspond to steps ST3b to ST5b of FIG. 9.

When no command showing permission or non-permission from the user (friend A) is issued in step ST3b, the mobile terminal enters a state in which it is waiting for a command. When the command is no permission to access (when NO in step ST4b), the mobile terminal shifts to a process of step ST7b.

Next, the authentication information manager 32 of the mobile terminal 3a generates, as encrypted data, restricted authentication information for permitting access to the content on a predetermined condition, that is, permitting a playback of the content on the predetermined condition. After that, the controller 34 adds the restricted authentication information generated by the authentication information manager 32 to a notification of the content access permission, and transmits this notification to the content playback device 1 by using the communication unit 35. The processes including up to this process correspond to step ST6b of FIG. 9.

Further, because the content access is not permitted in step ST7b, the authentication information manager 32 of the mobile terminal 3a rejects the content access permission request from the mobile terminal 3b, and generates a notification of the content access non-permission. This notification of content access non-permission is transmitted to the content playback device 1 by using the communication unit 35.

When the response to the request transmitted in step ST2a of FIG. 8 is received by the communication unit 14, the controller 13 of the content playback device 1 analyzes the description of the response.

At this time, when it is determined that the description of the response is a notification of the content access permission, the authentication information manager 12 holds the device information showing the mobile terminal 3b as device information of a mobile terminal for which a playback of the content is permitted.

For example, the device information held by the authentication information manager 12 is updated from the device information of the mobile terminal 3a to the device information of the mobile terminal 3b, and this device information is held. The processes including up to this process correspond to steps ST3a to ST5a of FIG. 8.

Next, the controller 13 transmits the notification of the content access permission to which the restricted authentication information from the mobile terminal 3a is added to the mobile terminal 3b by using the communication unit 14.

In contrast, when it is determined that the description of the response is a notification of the content access rejection (when NO in step ST4a), the controller 13 transmits the notification of the content access permission rejection to the mobile terminal 3b by using the communication unit 14 (step ST6a).

Also in these communications which the communication unit 14 performs, a wireless LAN, short-range radio communications, such as Bluetooth, or communications which are performed via another network, such as a cable network, can be used.

When the response to the request transmitted in step ST1 of FIG. 7 is received by the communication unit 35, the controller 34 of the mobile terminal 3b analyzes the description of the response. At this time, when it is determined that the description of the response is a notification of the content access permission, the authentication information manager 32 holds the restricted authentication information added to the notification of the content access permission. After that, the controller 34 commands the display controller 36 to display a screen notifying that content access by the friend B (mobile terminal 3b) has been permitted on the monitor 38.

In contrast, when it is determined that the description of the response is a notification of the content access permission rejection, the controller 34 commands the display controller 36 to display a screen notifying that content access by the friend B (mobile terminal 3b) has been rejected on the monitor 38.

The processes including up to this process correspond to steps ST2 to ST6 of FIG. 7.

The mobile terminal 3b acquires the restricted authentication information the above-mentioned way, and, as a result, even after the friend A gets off the vehicle, the friend B can continue watching the content provided by the friend's A media server 2 by using the restricted authentication information held by the mobile terminal 3b. More specifically, when the mobile terminal 3b makes a request for a playback of the content, the controller 13 of the content playback device 1 determines the mobile terminal 3b by using the device information held by the authentication information manager 12. When the permitted mobile terminal 3b is determined by the controller 13, the playback processor 11 plays back the content whose playback has been requested by the mobile terminal 3b on a predetermined condition. The content played back by the playback processor 11 is outputted from the speaker 15 and the monitor 16, and the friend B can continue watching the content.

As mentioned above, the content playback device 1 in accordance with this Embodiment 1 includes the authentication information manager 12 that holds device information showing a permitted mobile terminal 3b which is permitted to play back a content by an authenticated mobile terminal 3a, the controller 13 that, when the permitted mobile terminal 3b makes a request for playback of the content on the basis of restricted authentication information for permitting a playback of the above-mentioned content on a predetermined condition, the restricted authentication information being provided from the authenticated mobile terminal 3a to the above-mentioned permitted mobile terminal 3b, determines this mobile terminal 3b by using the device information held by the authentication information manager 12, and the playback processor 11 that, when the controller 13 determines the permitted mobile terminal, plays back the content provided from the media server 2 on the predetermined condition in response to the request from the above-mentioned mobile terminal 3b. By constructing the content playback device this way, even if the authenticated mobile terminal 3a stops the playback of the content, the content playback device can continue the playback of the content by using the other mobile terminal 3b permitted by the mobile terminal 3a.

Further, the mobile terminal 3a in accordance with this Embodiment 1 includes the controller that, when a content playback permission request including device information showing the above-mentioned mobile terminal from the other mobile terminal 3b is received, inquires a user whether or not to permit the other mobile terminal 3b to play back the content, and the authentication information manager 32 that, when permission to play back the content is accepted by the controller 34, generates restricted authentication information including the device information of the other mobile terminal 4b and used for permitting a playback of the content on a predetermined condition, and the controller 34 transmits the restricted authentication information generated by the authentication information manager 32 to the other mobile terminal 3b via the content playback device 1 that plays back the content to notify the device information of the other mobile terminal 3b to the content playback device 1 and provide the restricted authentication information for the above-mentioned other mobile terminal 3b.

By constructing the mobile terminal this way, the same advantage as that mentioned above is provided. By further transmitting the restricted authentication information to the mobile terminal 3b via the content playback device 1, the device information showing the other mobile terminal 3b which has been permitted by the mobile terminal 3a can be efficiently set to the content playback device 1.

### Embodiment 2

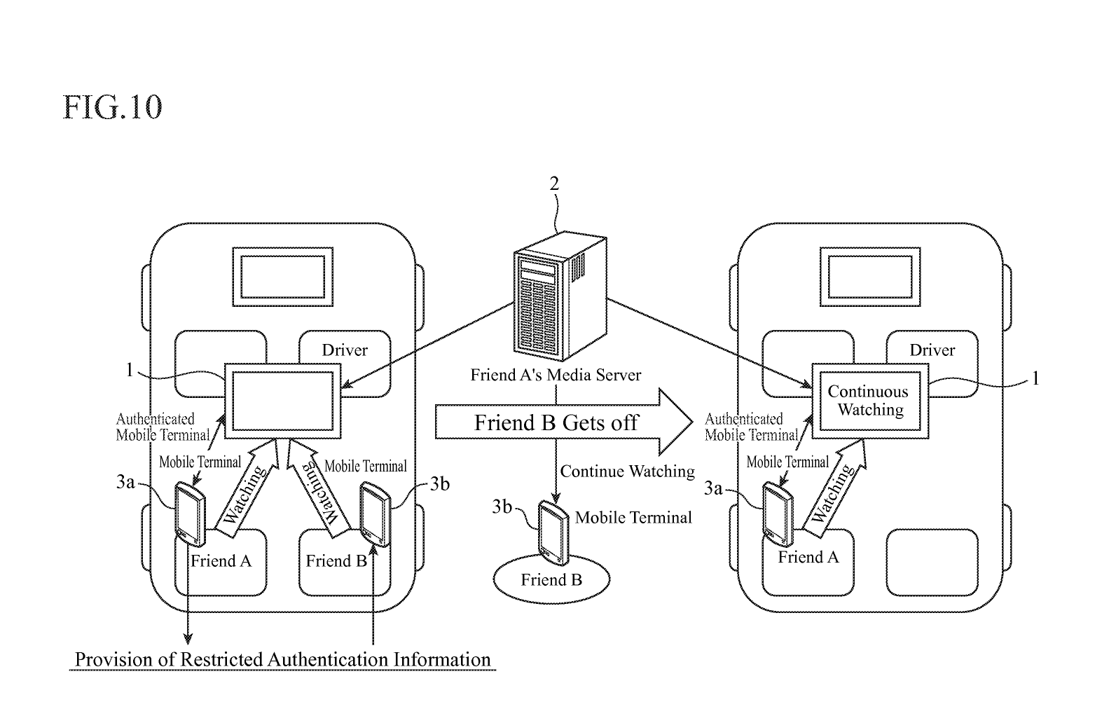

FIG. 10 is a view showing an outline of a content playback in accordance with Embodiment 2 of the present invention. In Embodiment 2, an explanation will be made by taking, as an example, a case in which, as shown in FIG. 10, when a friend A and a friend B have been watching a content in a media server 2 owned by the friend A who possesses a mobile terminal 3a by using a content playback device 1 (display device) mounted in a vehicle, and the friend B then stops watching and gets off the vehicle, and, even after that, the friend B continues watching the same content by using a mobile terminal 3b.

Also in this case, conventionally, because the mobile terminal 3b cannot access the content which the media server 2 manages after the friend B gets off the vehicle, the friend B becomes unable to continuously watch the content.

Therefore, in accordance with this Embodiment 2, when the friend B who possesses the mobile terminal 3b would like to watch the content continuously even after the friend B gets off the vehicle, the mobile terminal 3a provides a right to access the content and the media server 2 for the mobile terminal 3b with a restriction being imposed on the right, thereby solving the above-mentioned problem.

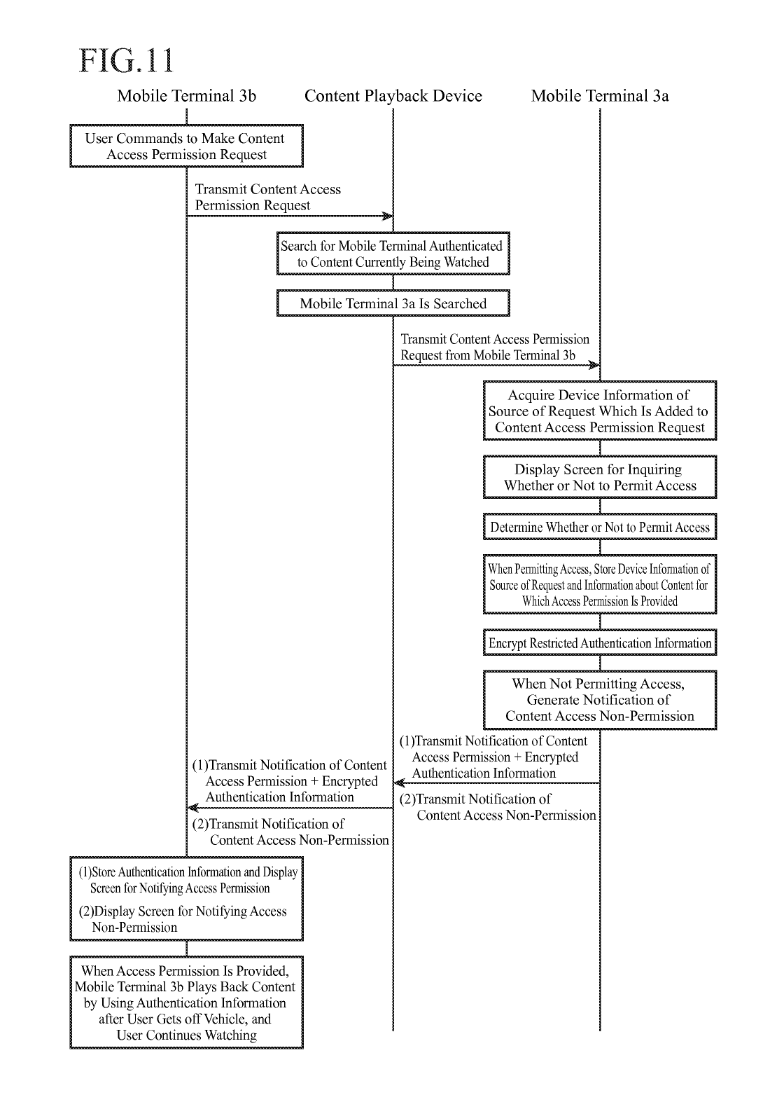

FIG. 11 is a timing chart showing a content continuous playback performed by a content playback system in accordance with Embodiment 2. As shown in FIG. 11, processes including up to a process of the mobile terminal 3b acquiring restricted authentication information from the mobile terminal 3a are the same as those in accordance with above-mentioned Embodiment 1.

In Embodiment 2, when the mobile terminal 3b of the friend B who has got out of the vehicle is authenticated by the media server 2 on the basis of the restricted authentication information, a playback processor 33 plays back the content provided by the media server 2 in response to a content access permission request (content playback request) on a predetermined condition. The content played back by the playback processor 33 is outputted from a speaker 37 and a monitor 38, and the friend B can continue watch the same content as that which he or she was watching within the vehicle.

A playback interruption information generator 10 of the content playback device 1 can add playback interruption information to a notification of the content access permission, and transmit this notification to the mobile terminal 3b. As a result, when playing back the content outside the vehicle, the playback processor 33 of the mobile terminal 3b can play back the continuation of the content which he or she was watching within the vehicle on the basis of the playback interruption information.

As mentioned above, in accordance with this Embodiment 2, the mobile terminal 3b includes an authentication information manager 32 that holds restricted authentication information for permitting a playback of a content on a predetermined condition, the restricted authentication information being provided thereto from the authenticated mobile terminal 3a, and the playback processor 33 that, when the mobile terminal 3b is authenticated by the media server 2 on the basis of the restricted authentication information held by the authentication information manager 32, plays back the content provided by the media server 2 on the predetermined condition in response to a content playback request.

By constructing the content playback system this way, the other mobile terminal 3b which is permitted by the authenticated mobile terminal 3a can continue playing back the content.

While the present invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the content playback device in accordance with the present invention can continue playing back a content by using another mobile terminal which is permitted by an authenticated mobile terminal, the content playback device is suitable for use as a vehicle-mounted content playback device with which a plurality of passengers watch a content.

### EXPLANATIONS OF REFERENCE NUMERALS

1 content playback device, 2 media server, 3a and 3b mobile terminal, 10 and 31 playback interruption information generator, 11 and 33 playback processor, 12, 26, and 32 authentication information manager, 13, 24, and 34 controller, 14, 25, and 35 communication unit, 15 and 37 speaker, 16 and 38 monitor, 20 authentication processor, 21 content manager, 22 content, 23 distribution processor, 30 input unit, 36 display controller, 39 playback interruption information manager, 40 device information manager.

1. A content playback device that, in response to a request from an authenticated mobile terminal which a server that manages contents has authenticated, plays back a content provided by said server, said content playback device comprising:
an authentication information manager that holds device information showing a permitted mobile terminal which is permitted to play back said content by said authenticated mobile terminal;
a controller that, when said permitted mobile terminal makes a request for playback of said content on a basis of restricted authentication information for permitting a playback of said content on a predetermined condition, said restricted authentication information being provided from said authenticated mobile terminal to said permitted mobile terminal, determines this mobile terminal by using the device information held by said authentication information manager; and
a playback processor that, when said controller determines said permitted mobile terminal, plays back the content provided from said server on said predetermined condition in response to the request from said mobile terminal.

2. A mobile terminal that has been authenticated by a server that manages a content, said mobile terminal comprising:
a controller that, when a content playback permission request including device information showing another mobile terminal from this mobile terminal is received, inquires a user whether or not to permit said other mobile terminal to play back said content; and
an authentication information manager that, when permission to play back said content is accepted by said controller, generates restricted authentication information including device information of said other mobile terminal and used for permitting a playback of said content on a predetermined condition, wherein
said controller transmits said restricted authentication information generated by said authentication information manager to said other mobile terminal via a content playback device that plays back the content to notify the device information of said other mobile terminal to said content playback device and provide said restricted authentication information for said other mobile terminal.

3. (canceled)
